(19) United States
(12) Patent Application Publication
(10) Pub. No.: US 2025/0275605 A1
(43) Pub. Date: Sep. 4, 2025

(54) A SHOE SOLE FORMED FROM A POLYMERIC FOAM COMPOUND WITH ENHANCED PERFOMANCE CHARACTERISTICS

(71) Applicant: Inoveight Limited, Crook, Durham (GB)

(72) Inventor: Douglas Edmund Sheridan, Surrey (CA)

(21) Appl. No.: 18/278,901

(22) PCT Filed: Feb. 25, 2022
(86) PCT No.: PCT/EP2022/054873

§ 371 Date: Aug. 25, 2023

(30) Foreign Application Priority Data
Mar. 2, 2021 (GB) 2102945.9

(51) Int. Cl. A43B 13/12

(52) U.S. Cl. CPC A43B 13/12

(57) ABSTRACT

The present invention provides for a sole for a footwear article, said sole is formed from a polymeric foam compound comprising: 28% to 32% by weight of an organic polymer; 38% to 40% by weight of Ethylene Vinyl Acetate (EVA); 21% to 25% by weight of an Olefin Block Copolymer (OBC); 7% to 10% by weight of BIIR-Butyl rubber, and 0.025% to 0.25% by weight of a Graphene-based material having lateral dimension in the region of 1 μm to 10 μm and a thickness in the region of 5 nm to 10 nm.

The present invention generally relates to footwear and, in particular, to sole(s) for a footwear article, such as, for example, performance shoes. More specifically, the present invention relates to a shoe sole(s) comprising a graphene-enhanced polymeric foam compound adapted to provide improvements in sole specific material characteristics.

### INTRODUCTION

Today, performance footwear, such as, for example, mountaineering boots, hiking or trail running shoes, road running shoes, track & field shoes or climbing shoes, is purposefully designed so as to provide an article that is optimised for a specific activity. Typically, these highly specialised footwear articles comprise material explicitly made for a particular function. Thus, when designing a modern performance shoe, every part of the shoe should ideally be optimised towards the intended use and application. For example, the upper may be particularly flexible, light and waterproof, or the toe box may be adapted to provide protection from rough terrain. The heel support may be particularly stiff to provide support to the ankle, and the fastening mechanism may be sufficiently adjustable to allow various settings. Efforts to improve such performance footwear may also include, inter alia, the reduction of weight, optimising the cushioning, the energy return, flexibility or stability, as well as, its durability and wear resistance.

Moreover, the impact force transmitted from the ground through the shoe and into the feet and legs of the user is believed to be one of the leading causes of foot injuries, wherein pain and discomfort in the feet and legs can result from long periods of walking or running, or any other sport. Also, numerous studies have highlighted potential health problems, such as bone fractures, cartilage degeneration and osteoarthritis, as well as, chronic knee and back pain as a consequence of such impact forces transmitted during sport activities, which can typically be around one and a half (1.5) to six (6) times the body weight (e.g. for walking and running).

Consequently, one of the most important mechanical properties of performance footwear, such as running shoes, hiking shoes or fitness shoes (HIIT) is its damping (cushioning) and rebound (energy return) behaviour, because optimised damping and rebound characteristics of the shoe can provide protection to the soft tissue of the human foot, as well as, support the involved muscle groups of the lower leg, thus, reducing or even preventing potential injuries to the user.

In order to improve the characteristics of performance shoes, midsoles are typically made from a variety of foam materials derived from synthetic polymers. In particular, Ethylene-Vinyl Acetate (EVA) became one of the standard materials for midsoles in running footwear, because it provides durability and flexibility at a low density. Other suitable materials may include Polyurethane (PU) foam, but its different cell structure is more suitably applicable in casual footwear than performance shoes. Also, PU foam materials are considerably denser than EVA foam materials, thus, soles made of PU material are much heavier than EVA foam soles.

FIG. 1 provides an example illustration of a performance shoe 10 (e.g. running shoe) in exploded view. The shoe 10 comprises an upper 12, an insole 14, a midsole 16 and an outsole 18. Here, the midsole 16 is made from, for example, an EVA foam compound that is adapted to provide a suitable cushioning and rebound during use.

However, one of the drawbacks of EVA foam material is its relative lack of durability, its loss of the performance characteristics through rapid ‘compression set’ of the midsole and its susceptibility to aging during long term usage, thus, resulting in a substantial loss of the initial benefits offered by EVA foam.

‘Compression set’ is understood as a thinning of an elastomeric foam material (e.g. the midsole 16), such as EVA, that is caused by excessive compression forces being placed repetitively on that material over time (e.g. through walking or running). ‘Compression set’ can be quite obvious as shown in FIG. 2, where microscopic cross sections are compared of (a) a new EVA midsole versus (b) a well-used EVA midsole. As is clearly visible in the Figures, the air bubbles (air filled closed cells) in the EVA running shoe midsole go from being nearly circular in size (e.g. averaging about 0.1 mm in diameter) and intact before use, to becoming flattened in size, or even burst or compress completely, after use. This change in the shape of the microscopic air bubbles of EVA over time (with or without compression from use) is believed to be at least partially caused by gas diffusion, i.e. air “leaking” out of the bubbles, thus, reducing the air pressure inside the bubbles and flattening the structures in the foam material, resulting in a loss of cushioning or a plane angulation of the shoe sole over time. Therefore, ‘compression set’ can be used as a characterising parameter for the lifecycle and longevity of a shoe. Typically, ‘compression set’ is measured by compressing a specimen, e.g. ca. 1.3 centimetre (cm) thick (ca. 0.5 inches), to 50% of its original thickness for a duration of about 22 to 24 hours (h) at an ambient temperature of about 50 degrees centigrade (° C.), then release the compressive load for a duration of another 24 h and measure the resultant thickness of the specimen (e.g. ASTM D3574-17 Test D).

Another important mechanical property of the midsole is its resilience (i.e. rebound or energy return). It represents the energy restored to the wearer by the cushioning material after an applied force ceases. So, a high resilience characteristic would have a fuller-recovery capacity of the midsole for the next footstep after a heel strike, and through to toe-off in the gait cycle, while a lower resilience characteristic (more viscous) would have the capacity of attenuating more energies at initial loading cycles, easily achieving compression flattening after some cycles and a loss of energy returned to the wearer.

Undoubtedly, the shoe sole (e.g. midsole) is one of the most important components of a performance shoe (e.g. running shoe, fitness shoe, hiking shoe or a specific shoe for team sports etc.), as it provides the functional interface between the foot of the user and the ground surface. Thus, if the shoe sole is not optimised (or at least adaptable) for a specific ground surface, terrain (e.g. tarmac, gravel, trail, mud, grass, rock etc.) or use (walking, running, jumping), the user may not be able to utilise his full potential. Further, the longevity of the characteristic parameters of currently available EVA soles is rather limited due to the relatively “fragile” composition of closed-cell EVA foam. Though, in order to avoid injuries, as well as, retain the benefits provided by the sole structure, such as the midsole, but also outsole and insole, runners have to replace their running shoes rather frequently, which could potentially have a significant impact on the environment.

Accordingly, it is an object of the present invention to provide an improved shoe sole material, such as a polymeric foam compound, that is adapted to provide improved mechanical properties, such as, for example, the ‘compression set’ and resilience, and thus, optimise performance and increase the overall longevity and sustainability of a performance shoe.

### SUMMARY OF THE INVENTION

Preferred embodiment(s) of the invention seek to overcome one or more of the disadvantages of the prior art.

According to a first aspect of the invention, there is provided a sole for a footwear article, said sole is formed from a polymeric foam compound comprising:
(i) 28% to 32% by weight of an organic polymer;
(ii) 38% to 40% by weight of Ethylene Vinyl Acetate (EVA);
(iii) 21% to 25% by weight of an Olefin Block Copolymer (OBC);
(iv) 7% to 10% by weight of BIIR-Butyl rubber, and
(v) 0.025% to 0.25% by weight of a Graphene-based material having lateral dimension in the region of 1 μm to 10 μm and a thickness in the region of 5 nm to 10 nm.

Preferably, the polymeric foam compound may comprise 0.05% to 0.12% by weight of said Graphene based material.

This unique combination of polymers and Graphene-based material provides the advantage of an elastomeric foam material with significantly improved durability (e.g. reduced compression set over time) and performance characteristics (e.g. optimised energy return). In particular, it is believed that the distinct range of the percentage and the specific type of Graphene-based material (i.e. nanoplatelets, sheets of functionalised Graphene of a limited range in particle size) contribute to a reduced loss (diffusion) of the fluid trapped in the closed-cell structure of the polymeric foam compound (i.e. providing a gas barrier for the trapped air), but also to an optimised stiffness (resilience) of the polymeric compound forming the closed-cell structure upon loading of the wearer during the gait cycle. In particular, the optimised amount and dimension of the Graphene-based material allows for optimised dispersion and provides a maximum resistance of the foam material to gas leakage or diffusion but without significantly altering its advantageous mechanical properties. In addition, during manufacture of the foam compound, certain aspects of the manufacturing process are improved. For example, manufacturing time (including heating and cooling periods) is reduced significantly due to the thermal properties (conductivity) of the Graphene-based material. Thus, the

[symbol]

Advantageously, said Graphene based material may comprise any one of or any combination of Graphene nanoplatelets, Graphene sheets (G) functionalised Graphene. Additionally, said functionalised Graphene may comprise any one of Graphene Oxide (GO) and reduced Graphene oxide (rGO).

Advantageously, a carbon (C) to Oxygen (O) ratio (C/O ratio) of said functionalised Graphene is 2.0 or higher.

Preferably, said Graphene-based material may has a lateral dimension in the region of 1 μm to 10 μm and a thickness in the region of 1 nm to 5 nm.

Advantageously, said organic polymer may comprise any one of or any combination by weight of a thermoplastic Polyurethane (TPU) and a Polyolefin elastomer (POE), a thermoplastic polyethylene (TPE), ethylene vinyl acetate (EVA).

Advantageously, said polymeric foam compound may comprise 26% to 30% by weight of an Olefin Block Copolymer (OBC). Preferably, said Olefin Block Copolymer (OBC) may be Ethylene-Octene Block Copolymer.

Advantageously, said polymeric foam compound further may further comprise:
(vi) 1% to 2% by weight of a foaming agent;
(vii) 0.8% to 1.5% by weight of a crosslinking agent;
(viii) 0.1% to 2% by weight of an assistant crosslinking agent;
(ix) 1% to 2% by weight of an activator.

Advantageously, said polymeric foam compound further may further comprise a filler material from any one substance, or any combination thereof, including: talcum powder, calcium carbonate (CaCO3), Montmorillonite, Zinc Stearate, Anti-aging agent, anti-abrasion agent, Azodicarbonamide (ADCA), Stearic Acid, Dicumyl Peroxide (DCP).

Advantageously, said Graphene-based material may be provided within an aqueous medium.

Preferably, said polymeric foam material may be an elastomeric closed-cell foam material.

Even more preferably, said sole may be any one of a midsole and an insole.

According to a second aspect of the invention, there is provided a method for producing a polymeric foam compound according to any one of the preceding claims, comprising the steps of:
(a) dispersing said Graphene-based material in a predetermined solvent with a dispersion mixer by mixing said Graphene-based material and said predetermined solvent for a predetermined first time period at a first mixer speed;
(b) blending said dispersed Graphene-based material with said organic polymer, EVA, OBC and BIIR-Butyl rubber with said dispersion mixer at a predetermined first temperature for a predetermined second time period at a second mixer speed, that is less than said first mixer speed, so as to form a first mixture;
(c) blending said first mixture with any one or any combination of said foaming agent, said crosslinking agent, said assistant crosslinking agent and activator with said dispersion mixer at said predetermined first temperature within said predetermined second time period at said second mixer speed, so as to form a plasticised mixture;
(d) processing said plasticised mixture into one or more pellets of a predetermined first size at a predetermined second temperature;
(e) press moulding a predetermined amount of said one or more pellets so as to form a polymeric foam body of predetermined shape;
(f) compression moulding said polymeric foam body, so as to form a sole for a footwear article.

Alternatively, step (e) may include using said plasticised mixture for injection moulding a polymeric foam body.

Advantageously, said predetermined solvent may be a non-polar solvent.

Preferably, said predetermined first time period may be in the region of 60 seconds (sec) and said first mixer speed in in the range of 60 rpm to 80 rpm. Said predetermined first temperature may be in the range of 110 to 120 degrees Centigrade (° C.), said second mixer speed is in the range of 35 rpm to 45 rpm, and said predetermined second time period is in the range of 7 to 10 minutes (min). Said predetermined second temperature may be in the range of 80° C. to 90° C. Said predetermined third temperature may be in the range of 150° C. to 180° C., said predetermined force is in the range of 165 kg to 175 kg, and said predetermined third time period is in the range of 5 min to 7 min.

Advantageously, said polymeric foam compound may have one or more of the following material characteristics before aging:
a density of around 0.22±0.03 g/cm³ to 0.26±0.03 g/cm³;
a compressive strength of 110±10 kPa (at 10% deformation);
a resilience of 57%±5%;
a Hysteresis Loss of 27%±3%, and
a compression set of 50%±5%.

Alternatively, said polymeric foam compound may have a density of up to 0.15±0.03 g/cm³ and a resilience of 60%±5%.

Advantageously, said polymeric foam compound has one or more of the following material characteristics after aging (after 10 days at 50° C.):
a compressive strength of 90+10 kPa (at 10% deformation);
a resilience of 48%±5%;
a Hysteresis Loss of 30%±3%, and
a compression set of 52%±5%.

### BRIEF DESCRIPTION OF THE DRAWINGS

Preferred embodiments of the present invention will now be described, by way of example only and not in any limitative sense, with reference to the accompanying drawings, in which:

FIG. 1 shows an exploded view of an example footwear comprising an upper, insole, midsole and outsole, wherein at least the midsole is made from a polymeric (elastomeric) foam compound material;

FIG. 2 shows microscopic cross sections of an EVA midsole (a) unused (no aging) and (b) well-used (as well as, after aging);

FIG. 3 shows the chemical structure of (a) graphene nanoplatelets (GNP, typically multi-layered), (b) graphene oxide (GO) and (c) reduced graphene oxide (rGO);

FIG. 4 shows a simplified illustration of the polymeric foam compound of the present invention where (a) graphene nanoplatelets (GNP) and (b) reduced graphene oxide (rGO) are dispersed within the polymer matrix;

FIG. 5 shows an illustration of the energy absorbed using hysteresis curves of the polymer foam compound material of the present invention and a polymeric foam compound material without Graphene-based material (a) before aging) and (b) after aging, and

FIG. 6 illustrates a direct comparison of the polymeric foam compound of the present invention and a polymeric foam compound without the Graphene-based material before and after aging.

### DETAILED DESCRIPTION OF THE PREFERRED EMBODIMENT(S)

The exemplary embodiments of this invention will be described in relation to the footwear and in particular to soles for footwear. Even more particularly, the present invention is in relation to a foam midsole for a footwear. However, it should be appreciated that the polymeric foam compound material of the present invention may also be used for any other part of the shoe sole, for example, the outsole, or both, the midsole and the outsole, but also the insole (i.e. footbed).

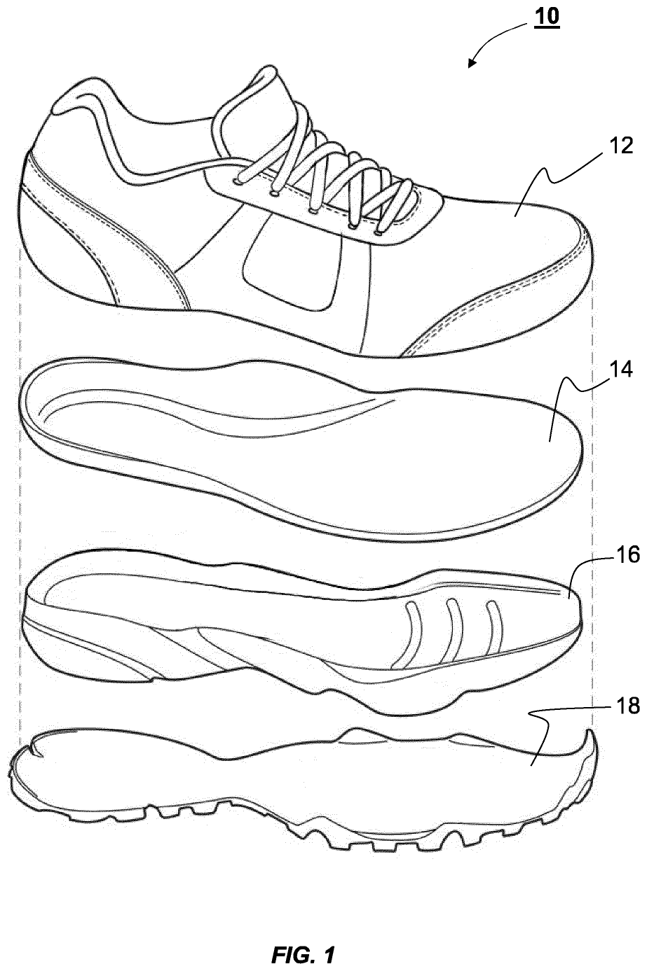

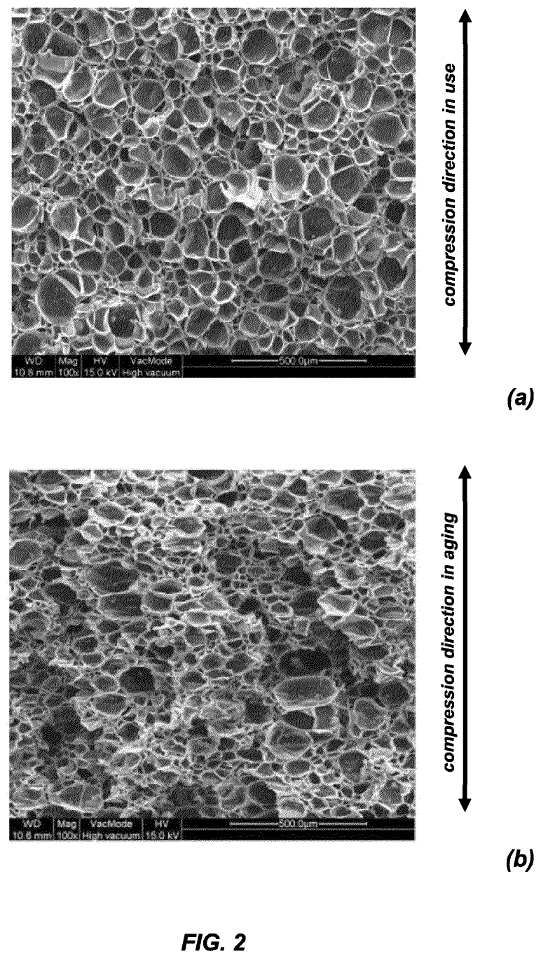

Referring to FIGS. 1 to 6, a shoe midsole (e.g. a midsole 16 such as shown in FIG. 1) is made from a graphene-enhanced polymeric foam compound material of the present invention. The polymeric (i.e. elastomeric) foam compound material comprises a mixture of at least 28% to 32% by weight of an organic polymer; 38% to 40% by weight of Ethylene Vinyl Acetate (EVA); 21% to 25% by weight of an Olefin Block Copolymer (OBC); 7% to 10% by weight of BIIR-Butyl rubber, and 0.025% to 0.25% by weight of a Graphene-based material. The organic polymer may be provided in the form of Thermoplastic Polyurethane (TPU) and/or Polyolefin Elastomer (POE) (any one or any combination of the two).

Preferably, the graphene-based material has a lateral dimension in the region of 1 μm to 10 μm and a thickness in the region of 5 nm to 10 nm. Even more preferably, the amount of the graphene-based material may be in the region of 0.05% to 012% by weight.

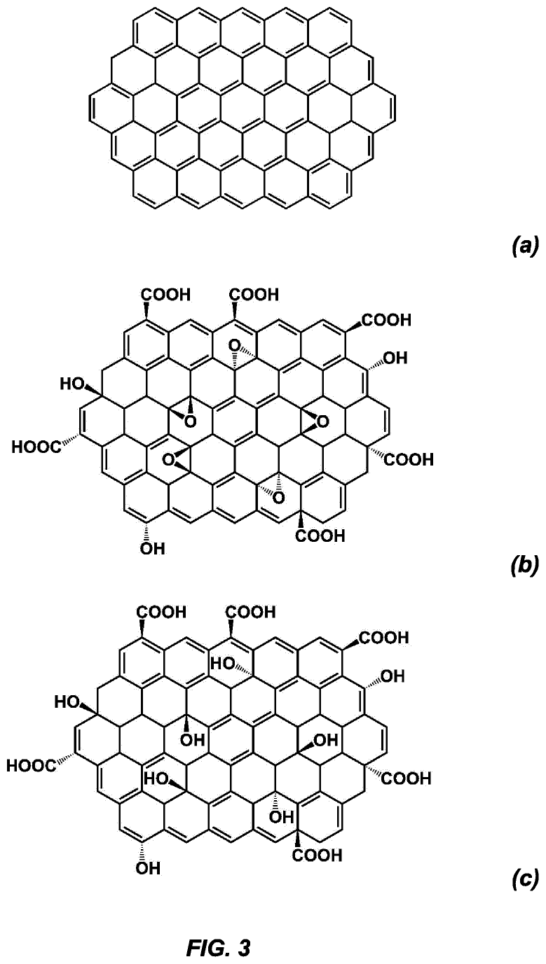

The graphene-based material may be provided in the form of Graphene nanoplatelets (GNP) or functionalised Graphene, such as, for example, Graphene Oxide (GO) or reduced Graphene Oxide (rGO). The graphene-based material may also be referred to as nanofiller. FIG. 3 illustrates simplified chemical structures of (a) Graphene nanoplatelets (single layer, typically GNPs are formed from multi-layered graphene, 1 nm-10 nm thick and 100 nm to 10 μm lateral size), and functionalised Graphene in the form of (b) Graphene Oxide (produced by oxidation and exfoliation of graphite, provided in single layer or multi-layered form, 1 nm-10 nm thick and 100 nm to 10 μm lateral size, and a C/O ration of about 2.0) and (c) reduced Graphene Oxide (reduced functional groups starting from Graphene Oxide (provided in single layer or multi-layered form, 1 nm-10 nm thick and 100 nm to 10um lateral size, and a C/O ratio that is greater than 2.0).

However, it is understood by a person skilled in the art that other Graphene-based materials formed by using alternative methods of functionalising Graphene may be equally used. For example, the Graphene Oxide (GO) utilised for the example embodiment of the invention is a GO provided by William Blythe Ltd as a 1% aqueous dispersion (10 mg/mL), a freeze-dried powder or in a flake form. Furthermore, the Graphene-based material may also be provided in gel-form (e.g. dispersed in a hydrophilic gel).

Preferably, the polymeric foam compound material of the present invention further comprises 26% to 30% by weight of an Olefin Block Copolymer (OBC), for example from an Ethylene-Octene Block Copolymer, as well as, 1% to 2% by weight of a foaming agent; 0.8% to 1.5% by weight of a crosslinking agent; 0.1% to 2% by weight of an assistant crosslinking agent, and 1% to 2% by weight of an activator.

Additional filler materials may be used from any one or any combination of talcum powder, calcium carbonate (CaCO3), Montmorillonite, Zinc Stearate, Anti-aging agent, anti-abrasion agent, Azodicarbonamide (ADCA), Stearic Acid, Dicumyl Peroxide (DCP), so as to “fine-tune” specific material characteristics of the polymer foam compound.

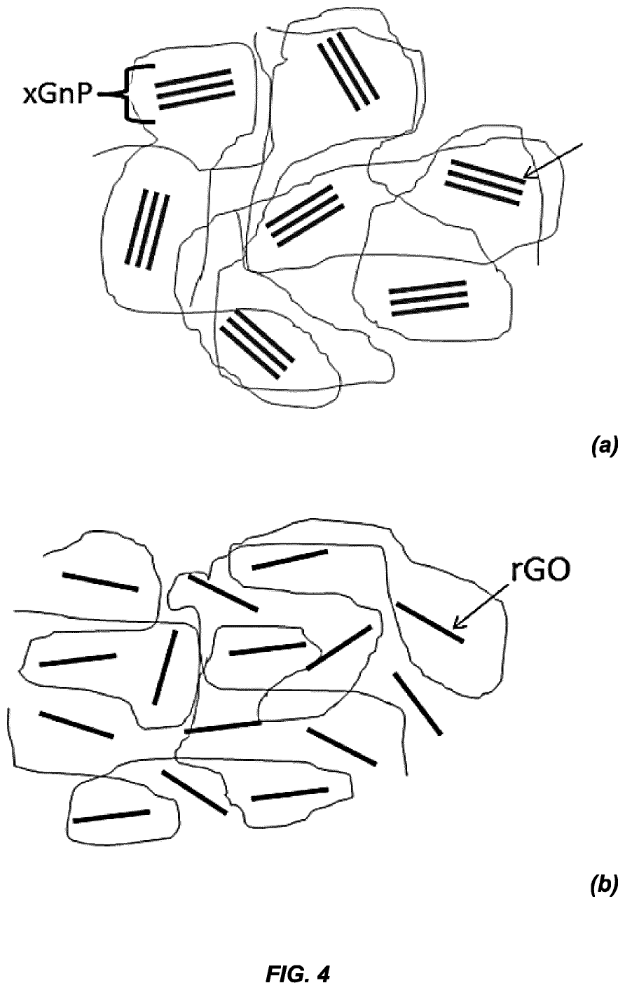

FIG. 4 shows a simplified illustration of the polymeric foam compound of the present invention where (a) graphene nanoplatelets (GNP) and (b) reduced graphene oxide (rGO) are dispersed within the polymer matrix.

It is generally understood that Graphene and other 2D nanoparticles with high aspect ratios display high affinity for the polymer matrix. The particles of nanofiller dispersed in the matrix may interact with it at the interphase boundary whose thickness depends on, inter alia, the matrix type and the nanocomposite production method. Thus, the primary difference between conventional fillers and nanofillers used with this invention (e.g. GNP, GO, rGO, with aspect ratios of about 100 to 10,000) is the ratio of surface area to a given mass. In particular, the surface area of Graphene-based nanofillers (e.g. GNP, GO, rGO) can be three orders of magnitude higher compared with conventional fillers. These characteristics can alter the type of interactions between the nanoparticles and polymer chains, where, for example, a relatively large surface area of Graphene-based nanofillers may allow for increasing the area of interactions among the Graphene-based nanofiller particles at the interphase boundary. This can cause drastic changes in the polymer matrix properties at a relatively low level of Graphene-based nanofiller content. Another important parameter that may affect the interphase interactions in nanocomposites such as the polymer foam compound material of the present invention is the Graphene-based nanofiller activity. For example, the effect of the Graphene-based nanofiller may be related to the arrangement of the Graphene-based material (i.e. nanofiller) inside the polymer matrix.

The unique combination of components of the polymeric foam compound with the Graphene-based material provides for a considerable improvement in the ‘compression set’ (ASTM D3574-17 Test D) and compressive strength (ASTM D3574-17 Test N) of foam materials, as well as, its resilience (ASTM D3574-17 Test H) and rebound (i.e. energy return, ASTM D3574-17, Test N).

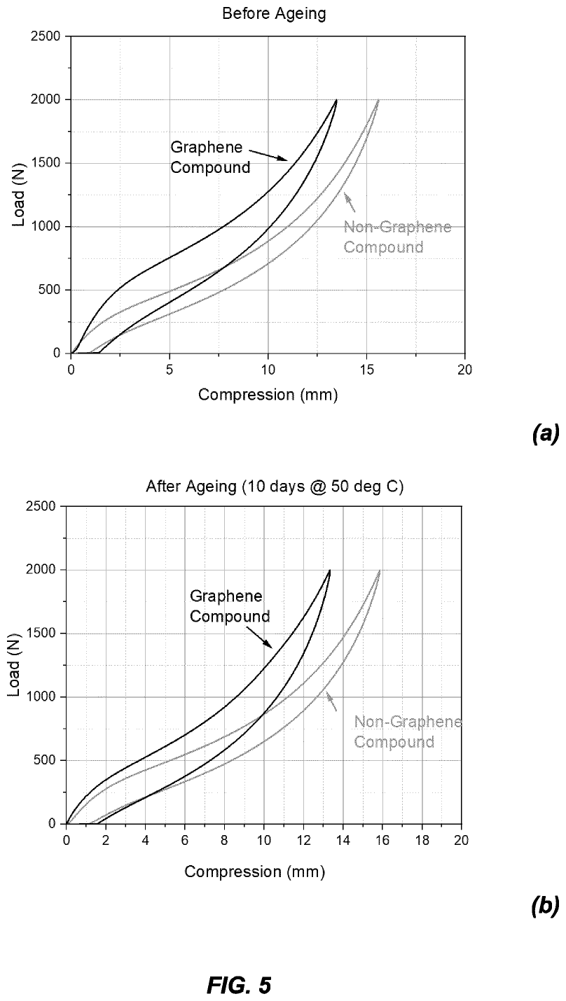

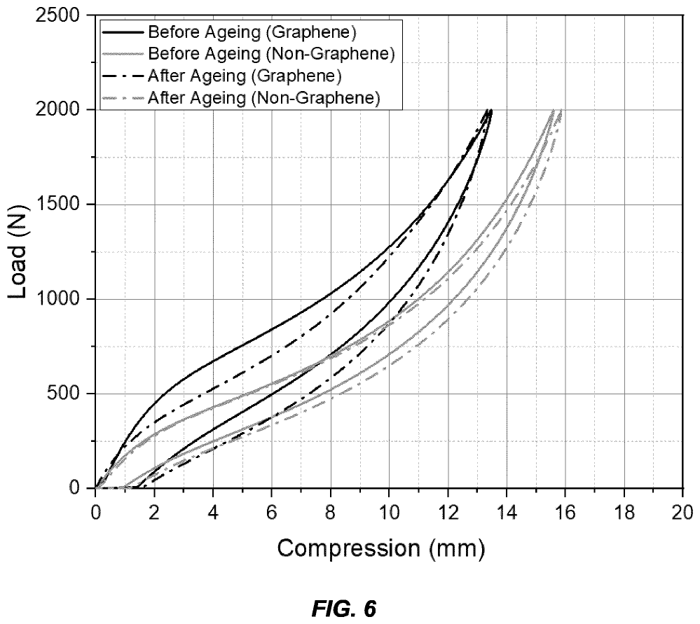

FIG. 5 shows hysteresis curves (i.e. the energy absorbed) of a sample of the polymeric foam compound of the present invention compared to a sample of a polymeric foam compound without the Graphene-based material (a) before aging and (b) after aging for 10 days at 50° C. FIG. 6 illustrates a direct comparison of the polymeric foam compound of the present invention and a polymeric foam compound without the Graphene-based material before and after aging.

Table 1 includes a summary of test results for the polymeric foam compound of the present invention (Graphene) compared to a sample of a polymeric foam compound without the Graphene-based material (Non-Graphene).

TABLE 1

| | | Before Ageing | | | After Ageing (10 days @ 50 deg C.) | | |
|---|---|---|---|---|---|---|---|
| | | Non- | | % | Non- | | % |
| | Test Standard | Graphene | Graphene | Improvement | Graphene | Graphene | Improvement |
| Density (g/cm³) | ASTM D3575-20 | 0.218 ± 0.01 | 0.256 ± 0.001 | n/a | n/a | n/a | n/a |
| | Suffix W | | | | | | |
| Compressive Strength | ASTM D3574-17 | 70 ± 0.003 | 110 ± 0.003 | 57% | 60 ± 0.003 | 90 ± 0.002 | 50% |
| @ 10% (kPa) | Test N | | | | | | |
| Resilience Test (%) | ASTM D3574-17 | 52 ± 2.5 | 57 ± 1.1 | 10% | 45 ± 0.5 | 48 ± 0.9 | 7% |
| | Test H | | | | | | |
| Hysteresis Loss Test | ASTM D3574-17 | 20 ± 0.72 | 27 ± 1.2 | −35% | 23 ± 1.0 | 30 ± 1.7 | −30% |
| (%) | Test N | | | | | | |
| Compression Test (%) | ASTM D3574-17 | 57 ± 0.3 | 50 ± 0.3 | 12% | 55 ± 1.2 | 52 ± 0.5 | 5% |
| | Test D | | | | | | |

All tests were performed in accordance with the ASTM standard referenced in Table 1, with the following deviations from the standard:

### Resilience Test:

ASTM: specimen (100×100×50) mm;
Method used: specimen (100×100×50) mm; where 50 mm was in the form of five samples with a 10 mm thickness;

### Compression Test:

ASTM: specimen (50×50×25) mm;
Method used: specimen (50×50×30) mm; where 30 mm was in the form of three samples with a 10 mm thickness;
   Hysteresis Loss Test/Compressive strength:
ASTM: specimen (50×50×25) m;
Method used: specimen (50×50×30) mm; where 30 mm was in the form of 3 samples with a 10 mm thickness;

### Density:

Method used: as described in ASTM standard.

As can be clearly seen from Table 1, as well as, the hysteresis curves of FIGS. 5 and 6, the polymer foam compound provides significant improvement of the mechanical properties, in particular, the ‘compression set’ and resilience (energy return), as well as, improvements of the deterioration of the material characteristics over time (i.e. after aging). Further, it is understood that the polymeric foam compound material may have a density in the region of 0.19 to 0.23, depending on the variation of BIIR-Butyl rubber.

### Preparation of the Polymeric Foam Compound Material

The compounding of nonpolar chains, such as polyolefins into midsoles can be difficult and often leads to an insufficient filler dispersion and with that a poor aggregation of the layers, which can deteriorate the mechanical properties of the polymer compound. The method of the present invention utilizes an in situ introduction of the Graphene-based material, as well as, additional fillers. This ensures an optimised dispersion of the Graphene-based material within the polymer compound.

The mixing of the Graphene-based material (GNP, GO, rGO etc.) and the polymer base materials (e.g. EVA, TPU/POE, TPE, OBC, BIIR-Butyl rubber) and the additives is performed by a Banbury mixing apparatus of industrial strength. Banbury mixers are well-known in the art and are often utilized in industry applications. Typically, polymer materials and other chemicals required for the polymer foam compound are “chemically” blended while heating at 110 to 120° C. for about 8-12 min under pressure (inside the mixer) utilising a twin pair of rotors having a specific shape and a rotor speed between 35 and 45 rpm (revolutions per minute).

The Banbury mixer plasticizes and blends polymer materials in a closed compartment, allowing a high mixing capacity, a short process time and a high production efficiency. The closed mixing chambers reduce the loss of dosing agents (e.g. Graphene in suspension or powdered form), and other foam promoters such as AC-DCP or Steric acid and improve product quality.

In one example method, a unique “upside down” mixture process is utilized, blending the Oil and the Graphene-based material, as well as, some of the other fillers in a first stage mix in a vigorous blending step (e.g. 60 to 80 rpm for a short period of about 60 seconds) to insure the safe handling of the Graphene-based material and to improve its dispersion.

During the mixing stage, a slower rotational rotor speed is utilised to avoid degradation of the polymer compound and to avoid increased “stickiness” of the polymer compound (often created by rotational mixers of a high strength and speed).

Furthermore, it is known that the aspect ratio of the Graphene-based material (GNP, GO, rGO sheets) reduces significantly during the mixing process, because of possible shredding of the Graphene-based material due to the high shear forces generated by the rotor(s) of the mixer, potentially causing a thickening of the material and resisting the full dispersion of the Graphene-based material.

Consequently, mixing parameters (e.g. rotor speed) so as to reduce the shear forces and reduce the viscosity of the base material.

Furthermore, the improved heat dissipation provided by the Graphene-based material, as well as its ability to act as a catalyst in bonding to the polymer structure, it is possible to achieve complete dispersion of the Graphene-based material at a reduced mixing speed.

After the Graphene-based material, filler and oil mixture is blended for about 60 seconds, the mixture is introduced right after the main polymers (TPU/POE, EVA, OBC, BIIT-Butyl rubber) are inserted, after which the filler are introduced. After that, the resulting polymer compound is mixed using the high-speed mixer, It is then carried out in 100° C. within the Banbury mixer for about 7 min to 10 min. After that, activator, foaming agents, assistant crosslinking agent and filler are added and are kneaded into the mixture.

The refining and granulation to pellet form is performed at temperatures between 80 to 85° C., using a twin-screw roller at a speed of about 70 rpm to 80 rpm. The resultant pellets are then placed In a foaming machine and moulded at a temperature of about 150 to 160° C. under a load of about 165 kg to 175 kg pressing on the foaming machine (i.e. and the pellets inside) for a process time of about 5 to 7 minutes. This is considerably faster than the processing time required for currently know materials that must stay in the foaming machine for as long as 9 min (similar thicknesses of units and base compound materials).

In another example method, the following steps may be followed in the particular order:
(i) dispersing said Graphene-based material in a predetermined solvent (e.g. oil) with a dispersion mixer (e.g. Banbury mixer) by mixing the Graphene-based material and the predetermined solvent (e.g. oil) for a 60 sec at a mixer speed of 60 rpm to 80 rpm;
(ii) blending the dispersed Graphene-based material (GNP, GO, rGO) with the organic polymer (TPU, POE), EVA, OBC and BIIR-Butyl rubber with the dispersion mixer at a about 110° C. to 120° C. for 7 to 10 min at about 35 rpm to 45 rpm mixer speed, so as to form a first mixture;
(iii) blending the first mixture with any one or any combination of a foaming agent, a crosslinking agent, an assistant crosslinking agent and an activator with the dispersion mixer at about 110° C. to 120° C. within the 7 min to 10 min period at 35 rpm to 45 rpm mixer speed, so as to form a plasticised mixture;
(iv) processing the plasticised mixture into one or more pellets (typically a plurality of pellets) at about 80° C. to 90° C.;
(v) press moulding a predetermined amount (determined for the size of the mould) of the pellets so as to form a polymeric foam body ('bun');
(vi) compression moulding the ‘bun’, so as to form a sole for a footwear article.

In yet another example method a single polymer (base polymer) may be used instead of the polymeric compound, i.e. without fillers or other additives to be blended with the Graphene material.

Further, it is understood by the person skilled in the art that the sole(s) may be produced by compression moulding or by injection moulding, or the polymeric foam compound material may simply be formed into a sheet and then cut into a desired shape.

It will be appreciated by persons skilled in the art that the above embodiment(s) have been described by way of example only and not in any limitative sense, and that various alterations and modifications are possible without departing from the scope of the invention as defined by the appended claims.

1. A sole for a footwear article, said sole is formed from a polymeric foam compound comprising:
(i) 28% to 32% by weight of an organic polymer;
(ii) 38% to 40% by weight of Ethylene Vinyl Acetate (EVA);
(iii) 21% to 25% by weight of an Olefin Block Copolymer (OBC);
(iv) 7% to 10% by weight of BIIR-Butyl rubber, and
(v) 0.025% to 0.25% by weight of a Graphene-based material having lateral dimension in the region of 1 pm to 10 pm and a thickness in the region of 5 nm to 10 nm.

2. A sole according to claim 1, comprising 0.05% to 0.15% by weight of said Graphene based material.

3. A sole according to claim 2, comprising 0.05% to 0.12% by weight of said Graphene based material.

4. A sole according to claim 1, wherein said Graphene based material comprises any one of or any combination of Graphene nanoplatelets, Graphene sheets (G) and functionalised Graphene.

5. A sole according to claim 4, wherein said functionalised Graphene comprises any one of Graphene Oxide (GO) and reduced Graphene oxide (rGO).

6. A sole according to claim 4, wherein a carbon (C) to Oxygen (O) ratio (C/O ratio) of said functionalised Graphene is 2.0 or higher.

7. A sole according to claim 1, wherein said Graphene-based material has a lateral dimension in the region of 1 pm to 10 pm and a thickness in the region of 1 nm to 5 nm.

8. A sole according to claim 1, wherein said organic polymer comprises any one of or any combination by weight of a thermoplastic Polyurethane (TPU) and a Polyolefin elastomer (POE).

9. A sole according to claim 1, comprising 26% to 30% by weight of an Olefin Block Copolymer (OBC).

10. A sole according to claim 1, wherein said Olefin Block Copolymer (OBC) is Ethylene-Octene Block Copolymer.

11. A sole according to claim 1, further comprising:
(vi) 1% to 2% by weight of a foaming agent; 0.8% to 1.5% by weight of a crosslinking agent;
(vii) 0.1% to 2% by weight of an assistant crosslinking agent;
(viii) 1% to 2% by weight of an activator.

12. A sole according to claim 1, further comprising a filler material from any one substance, or any combination thereof, including: talcum powder, calcium carbonate (CaCO3), Montmorillonite, Zinc Stearate, Anti-aging agent, anti-abrasion agent, Azodicarbonamide (ADCA), Stearic Acid, Dicumyl Peroxide (DCP).

13. A sole according to claim 1, wherein said Graphene-based material is provided within an aqueous medium.

14. A sole according to claim 1, wherein said polymeric foam material is an elastomeric closed-cell foam material.

15. A sole according to claim 1, wherein said sole is any one of a midsole and an insole.

16. A method for producing a polymeric foam compound according to claim 1, comprising the steps of:
(a) dispersing said Graphene-based material in a predetermined solvent with a dispersion mixer by mixing said Graphene-based material and said predetermined solvent for a predetermined first time period at a first mixer speed;
(b) blending said dispersed Graphene-based material with said organic polymer, EVA, OBC and BIIR-Butyl rubber with said dispersion mixer at a predetermined first temperature for a predetermined second time period at a second mixer speed, that is less than said first mixer speed, so as to form a first mixture;
(c) blending said first mixture with any one or any combination of said foaming agent, said crosslinking agent, said assistant crosslinking agent and activator with said dispersion mixer at said predetermined first temperature within said predetermined second time period at said second mixer speed, so as to form a plasticised mixture;
(d) processing said plasticised mixture into one or more pellets of a predetermined first size at a predetermined second temperature;
(e) press moulding said one or more pellets so as to form a polymeric foam body of predetermined shape;
(f) compression moulding said polymeric foam body at a predetermined third temperature over a predetermined third time period, so as to form a sole for a footwear article.

17. A method according to claim 16, wherein step (e) comprises using said plasticised mixture for injection moulding a polymeric foam body.

18. A method according to claim 16, wherein said predetermined solvent is a non-polar solvent.

19. A method according to claim 16, wherein said predetermined first time period is in the region of 60 seconds (sec) and said first mixer speed in in the range of 60 rpm to 80 rpm.

20. A method according to claim 16, wherein said predetermined first temperature is in the range of 110 to 120 degrees Centigrade (° C.), said second mixer speed is in the range of 35 rpm to 45 rpm, and said predetermined second time period is in the range of 7 to 10 minutes (min).

21. A method according to claim 16, wherein said predetermined second temperature is in the range of 80° C. to 90° C.

22. A method according to claim 16, wherein said predetermined third temperature is in the range of 150° C. to 180° C., said predetermined force is in the range of 165 kg to 175 kg, and said predetermined third time period is in the range of 5 min to 7 min.

23. A sole for a footwear article according to claim 1, wherein said polymeric foam compound has one or more of the following material characteristics before aging:
a density of around 0.22±0.03 g/cm³ to 0.26±0.03 g/cm³;
a compressive strength of 110±10 kPa (at 10% deformation);
a resilience of 57%±5%;
a Hysteresis Loss of 27% ±3%, and
a compression set of 50%±5%.

24. A sole for a footwear article according to claim 23, wherein said polymeric foam compound has a density of up to 0.15±0.03 g/cm³ and a resilience of 60%±5%.

25. A sole for a footwear article according to claim 1, wherein said polymeric foam compound has one or more of the following material characteristics after aging (after 10 days at 50° C.):
a compressive strength of 90±10 kPa (at 10% deformation);
a resilience of 48%±5%;
a Hysteresis Loss of 30%±3%, and
a compression set of 52%±5%.
